(19) United States
(12) Patent Application Publication
(10) Pub. No.: US 2016/0158672 A1
(43) Pub. Date: Jun. 9, 2016

(54) BIOFILM FILTRATION DEVICE AND BACKWASH METHOD FOR BIOFILM FILTRATION DEVICE

(71) Applicant: MITSUBISHI HEAVY INDUSTRIES, LTD., Minato-ku, Tokyo (JP)

(72) Inventor: Katsunori Matsui, Tokyo (JP)

(73) Assignee: MITSUBISHI HEAVY INDUSTRIES, LTD., Minato-ku, Tokyo (JP)

(21) Appl. No.: 14/908,782

(22) PCT Filed: Sep. 19, 2014
(86) PCT No.: PCT/JP2014/074850

§ 371 Date: Jan. 29, 2016

(30) Foreign Application Priority Data
Sep. 25, 2013 (JP) 2013-198259

(51) Int. Cl. B01D 24/46; C02F 3/00

(52) U.S. Cl. CPC B01D 24/4636; C02F 3/00; C02F 2101/10

(57) ABSTRACT

A non-chemical-feed biofilm filtration method is elucidated, and a biofilm filtration device that can achieve a desired filtration water quality level by controlling the backwash flow for a filter media is provided. The biofilm filtration device has a biofilm formed on the surface of a granular filter media filled into a filter vessel and cleans water to be filtered by passing the water in a filtration direction to a filter layer formed from the filter media. A backwashing mechanism is provided such that the flow velocity (V) for backwashing water passing through in a direction opposite to the filtration direction during backwashing of the filer media is set in a range having a lower limit which is a value (Vs) at which a prescribed backwashing effect can be obtained and an upper limit which is the value (Vm) when the backwashing expansion coefficient for the filter media is 0.

### TECHNICAL FIELD

The present invention relates to a biofilm filtration device that is used in a treatment such as water purification (pretreatment) on an upstream side of a desalination device in a seawater desalination system, for example, and a backwash method for a biofilm filtration device.

### BACKGROUND ART

In the related art, a biofilm filtration device (a filtration method) that purifies water by passing, water through a tower filled with a filter media such as sand, creating a biofilm on a surface of the filter media using organic nutrients in water, and removing dissolved organic substances and suspended particles (suspended solids) in the water using the biofilm.

The biofilm filtration device differs from filtration devices such as coagulation fillers, for example, and newly forms a biofilm on a surface of the filter media, but the organism repeatedly goes through a cycle of aging and regeneration. Consequently, waste material and biological excretion products of the organism move into the water and become new suspended particles (turbid portion).

In such a biofilm filtration device, in the same manner as other filtration devices, a driving operation that is referred to as backwashing is also required in order to eliminate dissolved organic matter and suspended particles that have been removed from the water from the filter after a predetermined driving period has elapsed, for example.

In addition, in a case of a downflow type biofilm filtration device in which target treatment water is caused to flow out from a lower section outlet by providing an inlet of target treatment water flow in an upper section, for example, in the manner disclosed in Patent Document 1 below, a technique that continues a biofilm filtration function of an entire filler layer has been known. The downflow type biofilm filtration device according to Patent Document 1 is provided with a flow inlet of a vapor or a liquid for cleaning in an upper layer section of a filler layer of a filler in a layer portion that is a ⅓ to ¼ from a top of a front layer portion bottom. Large floating matter deposited in the front layer section is only cleaned and removed using the flow inlet, as appropriate.

### CITATION LIST

### Patent Literature

Patent Document 1: Japanese Unexamined Patent Application Publication No 118-252590A

### SUMMARY OF INVENTION

### Technical Problem

Incidentally, in a raw water desalination system, for example, since water purification is implemented at the upstream side of a desalination device in the manner of a pretreatment of a seawater desalination device, biofilm filtration devices are adopted in a section of a small-scale plant. The biofilm filtration device performs a non-chemical-feed pretreatment, in which chemicals are not added to target treatment water such as seawater. However, although conventional non-chemical-feed pretreatments are economical and non-polluting, such pretreatments have little credibility at present. Consequently, non-chemical-feed biofilm filtration devices are not in a situation in which the non-chemical-feed biofilm filtration devices are adopted to new large-scale plants. The reason for this is that the understanding of non-chemical-feed biofilm filtration techniques is insufficient, and accordingly, it is not possible to achieve a desired filtered water quality (SDI) level using water purification.

In addition, biofilm filtration devices perform backwashing in order to remove turbid portions that are attached to a biofilm on the surface of a filter media, but in downflow type filtration devices, backwashing is performed with upflow backwash water in a direction opposite to the normal flow direction. However, as a result of this kind of backwashing, particulate filter media flows and becomes mixed together in a filter media layer of the biofilm filtration device, and a. portion of the biofilm that is attached to the surface of the filter media peels away and becomes fine particles. Although some of these peeled-away fine particles are discharged along with backwash water, the remainder of the peeled-away fine particles remain in the filter media layer and age.

Furthermore, in downflow type biofilm filtration devices, there is a large amount of organic matter that is dissolved in the target treatment water on an upstream filter media layer inlet side. Consequently, an organic attachment amount of the surface of the filter media is high on an upstream side of the filter media layer, and low on a downstream side in which there is little dissolved organic matter.

However, there is a concern that, the organic attachment amount is reversed at the upstream side and downstream side of the filter media layer as the peeling away of the biofilm proceeds as a result of mixing together and agitation of the filter media that occurs during backwashing. In a case in which driving of water purification is implemented in a state in which this kind of a reversal of the organic attachment amount occurs, aging because of organic nutrient deficiency is fluster on the filter layer downstream side in which there is little dissolved organic matter. As a result of this, a large amount of turbid portion is generated in the filter layer. The turbid portion is mixed into filtration water and raises (worsens) the filtration water quality (SDI). Accordingly, it is not preferable to perform agitation and mixing together of the filter media during backwashing.

That is, in order to remove a turbid portion in the target treatment water, it is necessary to perform fluid washing of the filter layer using backwashing. However, because fluid washing is a cause of deteriorations in water quality of filtration water, it is desirable to improve the reliability of economical, non-polluting, non-chemical-feed biofilm filtration devices (filtration methods) by preventing or suppressing agitation and mixing together of the filter media as a result of controlling the fluidity of the filter media by backwashing.

The present invention was devised in order to solve the abovementioned technical problem, and objects of the present invention are to elucidate a non-chemical-feed biofilm filtration method, and provide a biofilm filtration device that can achieve a desired filtration water quality level by controlling the fluidity of a filter media using backwashing and a backwash method for a biofilm filtration device.

### Solution to Problem

The present invention adopts the following means in order o solve the abovementioned technical problem.

A biofilm filtration device according to a first aspect of the invention has a biofilm formed on a surface of a granular filter media filled into a filter vessel (filtration tower). The biofilm purifies water to be filtered by passing the water in a filtration direction to a filter layer formed from the filter media. A backwashing mechanism of the biofilm filtration device is provided such that a flow velocity (V) for backwashing water passing through in a direction opposite to the filtration direction during backwashing of the filter media is set in a range having a lower limit which is a value at which a prescribed backwashing effect can be obtained and an upper limit which is a value when a backwashing expansion coefficient for the filter media is 0.

According to such the biofilm filtration device of the first aspect of the invention, since the backwashing mechanism is provided such that the flow velocity (V) for backwashing water passing through in a direction opposite to the filtration direction during backwashing of the filter media is set in a range having a lower limit which is a value at which a prescribed backwashing effect can be obtained and an upper limit which is a value when a backwashing expansion coefficient for the filter media is 0, it is possible to obtain an effective backwashing effect by setting the filter media to a non-fluid state.

In this case, it is preferable that the flow velocity (V) at which the predetermined backwashing effect, can be obtained is set to a value during which changes in turbidity or an uncleanness coefficient of backwash discharge water decrease to a predetermined value or less within a predetermined time after temporarily rising following initiation of backwashing.

A biofilm filtration device according to a second aspect of the invention has a biofilm formed on to surface of a granular filter media filled into a filter vessel. The biofilm purifies water to be filtered by passing the water in a downward direction to the filter layer formed from the filter media. The filter layer is divided, into a plurality of layers in the vertical direction, and a filter media particle diameter of an upper layer side is set to a value that is larger than a filter media particle diameter of a lower layer side.

According to such a biofilm filtration device of the second aspect of the invention, since the filter layer is divided into a plurality of layers in the vertical direction, and a filter media particle diameter of the upper layer side is set to a value that is larger than a filter media particle diameter of the lower layer side, although the upper layer side filter media flows by the upward flow of backwash water during backwashing, the light lower layer side filter media having a small diameter attains a state in which the upper surface of the lower side filter media is held down by the heavy upper layer side filter media having a large diameter. Therefore, since it is possible to prevent or suppress the fluidity of a lower layer filter media, it is possible to prevent a circumstance in which the upper layer side filter media and the lower layer side filter media, which form the filter layer, become agitated and mixed together by backwashing.

In this case, it is desirable that particle diameter of the upper layer side filter media be set to approximately 1.5 to 3 times the particle diameter of the lower layer side filter media.

In the abovementioned aspect, it is preferable that a mixture prevention material is interposed between divided surfaces of the filter layer. The mixture prevention material reliably suppresses the fluidity of the light lower layer side filter media. Therefore, it is possible to reliably prevent agitation and mixing together with the upper layer side filter media as a result of backwashing. In this case, a reticulated material or the like can be included as an example of a suitable mixture prevention material.

In the abovementioned aspect, it is preferable that a fluidization prevention material is provided on an upper surface of the filter layer. The fluidization prevention material reliably prevents the fluidity by holding the filter media down in a downward direction from the upper surface of the filter layer. Therefore, it is possible to reliably prevent agitation and mixing together with the upper layer side filter media as a result of backwashing. In this case, a grid structure material or the like that has a weight of an extent that does not float up as a result of backwash water flowing therethrough, can be included as an example of a suitable fluidization prevention material.

In a biofilm filtration device having a biofilm formed on a surface of a granular filled into a filter vessel, the biofilm purifying water to be filtered by passing the water in a downward direction to the filter layer formed from the filter media, a fluidization prevention material may he provided on an upper surface of the filter layer. That is, the filter layer may be set as a single layer that is not divided in a vertical direction, and agitation and mixing together may be prevented by installing a fluidization prevention material such as a grid structure material on the upper surface of the filter layer.

A backwash method for a biofilm filtration device according to a third aspect of the invention is a method wherein the biofilm filtration device has a biofilm formed on a surface of a granular filter media filled into a filter vessel, the biofilm purifies water to be filtered by passing the water in a filtration direction to a filter layer formed from the filter media. A flow velocity (V) for backwashing water passing through in a direction opposite to the filtration direction during backwashing of the filter media is set in a range having a lower limit which is a value at which a prescribed backwashing effect can be obtained and an upper limit which is a value when the backwashing expansion coefficient for the filter media is 0.

According to such a backwash method for a biofilm filtration device of the third aspect of the invention, since the flow velocity (V) for backwashing water passing through in a direction opposite to the filtration direction during backwashing of the filter media is set in a range having a lower limit which is a value at which a prescribed backwashing effect can be obtained and an upper limit which is a value when the backwashing expansion coefficient for the filter media is 0, it is possible to obtain an effective backwashing effect by setting the filter media to a non-fluid state.

In this case, it is preferable that the flow velocity (V) at which the predetermined backwashing effect can be obtained is set to a value during which changes in turbidity or an uncleanness coefficient of backwash discharge water decrease to a predetermined value or less within a predetermined time after temporarily rising following initiation of backwashing.

A filter media backwash method for a biofilm filtration device according to a fourth aspect of the invention is a method wherein the biofilm filtration device has a biofilm formed on a surface of a granular filled into a filter vessel, the biofilm purifies raw water to be filtered by passing the water in a downward direction to a filter layer formed from the filter media. The filter layer is divided into a plurality of layers in a vertical direction. A filter media particle diameter of an upper layer side is set to a value that is larger than a filter media particle diameter of a lower layer side. With respect to the upward flow of backwash water that is passed through during backwashing of the filter media, the filter media is set to be capable of flowing on the upper layer side and set to be incapable of flowing on the lower layer side.

According to such a backwash method for the biofilm filtration device of the fourth aspect of the invention, since the filter layer is divided into a plurality of layers in the vertical direction, a particle diameter of an upper layer side is set to a value that is larger than a filter media particle diameter of a lower layer side, and with respect to the upward flow of backwash water that is passed through during backwashing of the filter media, the filler media is set to be capable of flowing on the upper layer side and set to be incapable of flowing on the lower layer side, it is possible to prevent a circumstance in which the upper layer side filter media and the lower layer side filter media, which form the filter layer, become agitated and mixed together.

In this case, it is desirable that the particle diameter of the upper layer side filter media be set to approximately 1.5 to 3 times the particle diameter of the lower layer side filter media.

### Advantageous Effects of Invention

According to the abovementioned present invention, it is possible to prevent a circumstance in which the filter media becomes agitated and mixed together during backwashing, and as a result of this, it is possible to achieve a desired filtration water quality level using water purification. Accordingly, the reliability of economical, non-polluting non-chemical-feed biofilm filtration devices (filtration methods) is improved, and such devices can be used in new large-scale plants.

### BRIEF DESCRIPTION OF DRAWINGS

FIG. 1 is a view that illustrates a first embodiment of a biofilm filtration device and a backwash method for a biofilm filtration device according to the present invention, and is a view that illustrates a relationship between a flow velocity in the periphery of a filter media and a backwashing effect during backwashing.

FIG. 2 is a view that illustrates a relationship between backwashing time and turbidity at differing flow velocities 1 and 2 during backwashing.

FIG. 3A is a view that illustrates a second embodiment of the biofilm filtration device and the backwash method for a biofilm filtration device according to the present invention, and is a longitudinal section of the biofilm filtration device.

FIG. 3B is a view that illustrates the second embodiment of the biofilm filtration device and the backwash method for a biofilm filtration device according to the present invention, and is a definitive explanatory diagram that relates to changes in the fluidity of a filter media.

FIG. 4 is a longitudinal section that illustrates a third embodiment in the biofilm filtration device that is illustrated in FIG. 3A.

FIG. 5 is a longitudinal section that illustrates a fourth embodiment in the biofilm filtration device that is illustrated in FIG. 3A.

FIG. 6 is a system diagram that illustrates a configuration example of a desalination plant in which the biofilm filtration device and the backwash method for a biofilm filtration device according to the present invention are adopted.

### DESCRIPTION OF EMBODIMENTS

### First Embodiment

Hereinafter, a first embodiment of a biofilm filtration device and a backwash method for a biofilm filtration device according to the present invention will be described on the basis of the drawings.

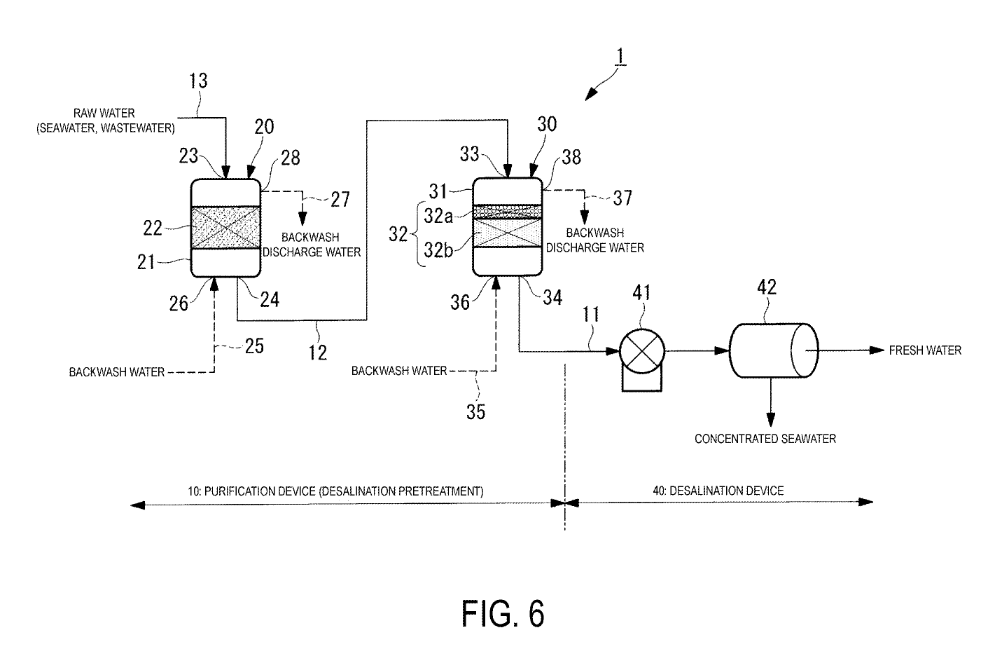

A desalination plant I of the embodiment that is illustrated in FIG. 6 is an apparatus that desalinates raw water (target treatment water) such as seawater or wastewater. The desalination plant 1 that is illustrated is configured by installing a purification device 10, which performs a desalination pretreatment (hereinafter, referred to as a “pretreatment”) of seawater, and a desalination device 40, which desalinates seawater after pretreatment (primary treated seawater). Additionally, the purification device 10 and the desalination device 40 are connected via a pipe 11.

Since the purification device 10 pretreats seawater in two stages, the purification device 10 has a configuration in which a downflow type primary biofilm filtration device (hereinafter, referred to as a “primary filtration device”) 20 and a secondary biofilm filtration device (hereinafter, referred to as a “secondary filtration device”) 30 are connected in series via a connection pipe 12. That is, after a first stage of pretreatment (a primary pretreatment) has been initially carried, out on seawater, which is target treatment water, primary treatment seawater is guided through the connection pipe 12 to the secondary filtration device 30.

The illustrated purification device 10 illustrates a form that performs filtration treatment in a downflow manner in a vertical direction, but is not limited to this configuration. The filtration treatment direction may be diagonally downward with respect to a vertical direction, or may be a horizontal direction.

The primary treatment seawater that is guided to the secondary filtration device 30 becomes secondary treatment seawater on which a second stage of pretreatment (a secondary pretreatment) has been carried out, and the secondary treatment seawater is supplied through the pipe 11 to the desalination device 40. Accordingly, a considerably larger amount recovered matter such as dissolved organic matter and suspended particles is removed by the primary filtration device 20 than the secondary filtration device 30.

In this case, an economical, non-polluting, non-chemical-feed pretreatment is performed in the primary filtration device 20 and the secondary filtration device 30.

The seawater that is purified in the primary filtration device 20 and the secondary filtration device 30 is supplied from the purification device 10 to the desalination device 40 via the pipe 11.

The desalination device 40 is provided with a pump 41 that introduces purified seawater, and a reverse osmosis membrane 42 that separates seawater into fresh water and concentrated seawater.

The downflow type primary filtration device 20 is a device in which a filter layer 22 is formed by filling the inside of a filter vessel (a filtration tower) 21 with sand (a granular filter media), and which performs a non-chemical-feed pretreatment by forming a biofilm on the surface of the sand (the surface of the filter media) of the filter layer 22. Additionally, the filter layer 22 is installed in an intermediate portion of the filtration tower 21 leaving appropriate space portions thereabove and below.

An inlet opening 23, which introduces seawater into the inside of the vessel, is provided in an upper section of the filter vessel 21 connected to raw water pipe 13.

In addition, an outlet opening 24 which connects to the connection pipe 12, is provided in a lower section of the filter vessel 21 in order to discharge primary pretreatment seawater and lead the primary pretreatment seawater to the secondary filtration device 30.

Furthermore, the primary filtration device 20 is provided with a backwashing mechanism in order to remove recovered matter of the filter layer 22. As the backwashing mechanism, a backwash inlet opening 26 is provided in a lower section of the filter vessel 21 for connection with a backwash water supply pipe 25 in order to supply backwash cleansing water from a water source that is not illustrated, and a backwash outlet opening 28, which is open to a space portion that is above the filter layer 22, is also provided in an upper section of the filter vessel 21 for connection with a backwash discharge water pipe 27 in order to discharge backwash discharge water. A pump, which is not illustrated, is used in the supply of the abovementioned backwash cleansing water.

Additionally, opening and closing valves, which are not illustrated, are provided in appropriate locations in the raw water pipe 13, the connection pipe 12, the backwash water supply pipe 25 and the backwash discharge water pipe 27.

The downflow type secondary filtration device 30 is provided with the same backwashing mechanism as the primary filtration device 20, and is a device in which a filter layer 32 is formed by filling the inside of a filter vessel 31 with sand, and which performs a non-chemical-feed pretreatment by forming a biofilm on the surface of the sand (the surface of the filter media) of the filter layer 32.

Apart from the configuration of the filter layer 32, which is divided in two into an upper section filter layer 32a and at lower section filter layer 32b, the secondary filtration device 30 that is illustrated effectively has the same configuration as that of the primary filtration tower 20. Additionally, the reference numeral 33 in the drawing is an inlet opening that is connected to the connection pipe 12, 34 is an outlet opening that is connected to the pipe 11, 35 is a backwash water supply pipe, 36 is a backwash inlet opening, 37 is a backwash discharge water pipe, and 38 is a backwash outlet opening.

In the abovementioned primary filtration device 20 and the secondary filtration device 30 of the present embodiment, these filtration devices have a biofilm formed on a surface of sand filled into the filter vessel 21, and the biofilm purifies water to be filtered (seawater and primary treatment seawater) by passing the water to the filter layers 22 and 32 formed from sand. In the backwashing mechanism of the biofilm filtration device, a flow velocity (V) for backwashing water passing through in the upward direction during backwashing of the filter media is set in a range having a lower limit which is a value at which a prescribed backwashing effect can be obtained and an upper limit which is a value when the backwashing expansion coefficient for the filter media is 0. In this manner, if backwashing is implemented by setting the backwash water to within an appropriate range of flow velocity, it is possible to obtain an effective backwashing effect by setting the filter media flow velocity to a non-fluid state.

Incidentally, in the abovementioned downflow type biofilm filtration device of the present embodiment, upward indicates a direction that is opposite to a normal water direction of filtration target water, which is a filtration direction. That is, upward is indicated with respect to a form that performs filtration treatment in a downflow manner in a vertical direction as illustrated, but upward is not limited to a direction with respect to a vertical direction, and is diagonally upward in an opposite direction with respect to a form that performs filtration treatment in a diagonally downward manner.

In addition, the backwash expansion coefficient indicates at ratio of a rise in height with respect to a filter media height during a phenomenon in which the sand of the filter media rises (expands) as a result of being subject to the upward flow of the backwash cleansing water. The backwash expansion coefficient is set to 0 when the phenomenon in which the sand of the lifter media rises (expands) as a result of being subject to the upward flow of the backwash cleansing water, is not observed during backwashing of the filter media.

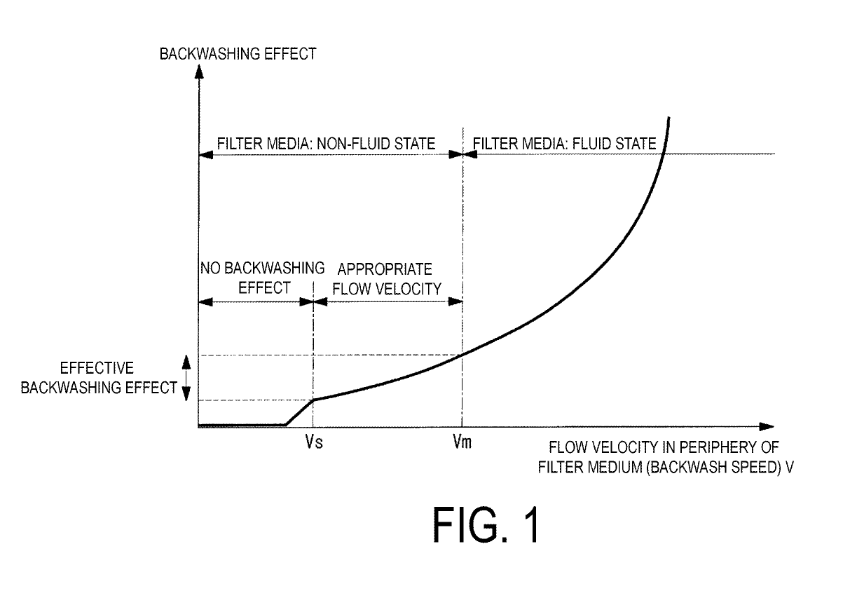

If the abovementioned appropriate range of flow velocity of the backwash water is described specifically, as illustrated in FIG. 1, the flow velocity (V) of the backwash water in the periphery of the filter media is set within a range (Vs ≦V ≦Vm) from a flow velocity (Vs) at which there is no backwashing effect, to a flow velocity (Vm) at which the filter media attains a non-fluid state.

At a backwash speed (V) that is determined by the equation that is shown by Formula I below, an upper limit flow velocity (Vm), at which the filter media attains a non-fluid state, is a calculated value of a case in which the backwash expansion coefficient (es) of the filter media that is shown in the equation is set as 0. That is, if the flow velocity of the backwash water exceeds and is greater than the upper limit flow velocity (Vm), the filter media becomes fluid and this is not preferable.

[Formula 1]

V=0.139ds^{3/2} (1+0.06es) (9t+310) cs^{2/3}
V=backwash speed (cm/min)
t=water temperature (° C.)
ds=effective diameter of sand (m/m)
es=expansion coefficient of sand (%)
cs=uniformity coefficient of sand

Additionally, the equation is cited in “Water Treatment Technology Vol. 5, No. 9, 1964 by Shinohara Osamu”.

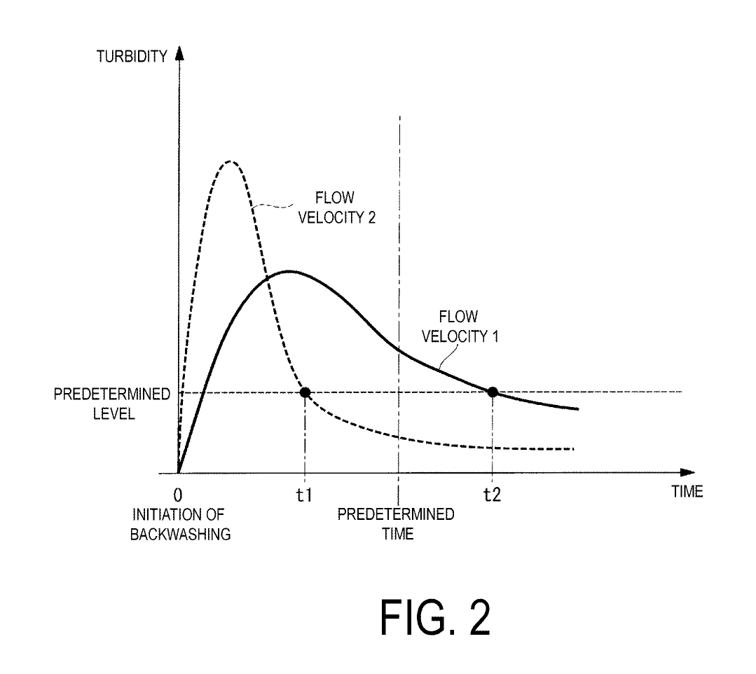

In addition, it is preferable that the flow velocity (Vs) at which the predetermined backwashing effect can be obtained is set to a value during which changes in turbidity or an uncleanness coefficient of backwash discharge water decrease to a predetermined value or less within a predetermined time after temporarily rising following initiation of backwashing. If this feature is described specifically on the basis of FIG. 2, for a flow velocity 1 of backwash water, which is displayed. by a solid line, a time t2, during which turbidity decreases to a predetermined level after temporarily rising, exceeds a predetermined time. However, for a flow velocity 2 of backwash water, which is displayed by a broken line, a time t1, during which turbidity decreases to the predetermined level after temporarily rising, is less than the predetermined time.

Accordingly, as the abovementioned flow velocity 2, it is sufficient as long as the flow velocity (Vs) at which the predetermined backwashing effect can be obtained, is set by finding a value at which turbidity decreases to a predetermined level, within a predetermined time after temporarily rising following initiation of backwashing, using a sampling experiment or the like.

That is, by using a backwash method in which the flow velocity (V) for backwash water passing through in an upward direction during backwashing of the filter media is set in a range having a lower limit which is a value (Vs) at which a predetermined backwashing effect can be obtained and an upper limit which is a value (Vm) when a backwashing expansion coefficient of the filter media is set to 0, it is possible to obtain an effective backwashing effect by setting the filter media to a non-fluid state.

### Second Embodiment

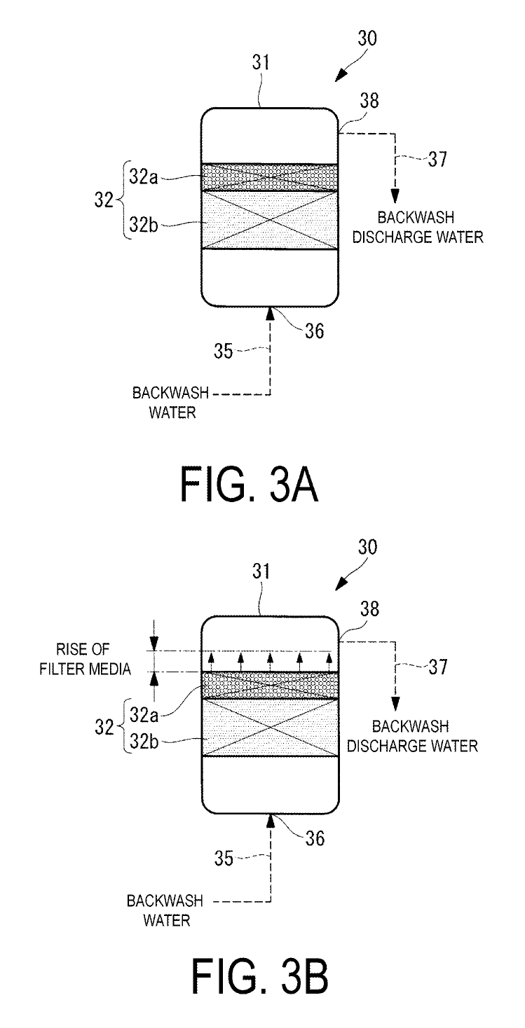

Next, a second embodiment will be described on the basis of FIGS. 3A and 3B. Additionally, the same reference numerals are given to the same portions as those of the first embodiment, and detailed description thereof will be omitted.

In this embodiment, a two-layered structure of the abovementioned filter layer 32 is a structure in which the sand particle diameter that forms the upper section filter layer 32a is set to be a larger particle diameter than the sand particle diameter of the lower section filter layer 32b, and the filter layer 32 that flows during backwashing, which is upward flow of the backwash cleansing water, is limited to the upper section filter layer 32a. That is, since the particle diameter of the sand that forms the upper section filter layer 32a is, for example, set to approximately 1.5 to 3 times the particle diameter of the sand that forms the lower section filter layer 32b, the lower section filter layer 32b attains a state in which a large number of heavy, large diameter particles are loaded on the upper surface thereof. in other words, the two-layered structure filter layer 32 attains a state in which the upper surface of the light lower section filter layer 32b haying small particle diameters is held down from above by the heavy upper section filter layer 32a.

Such a present embodiment is a backwash method for a biofilm filtration device that divides the filter layer 22 into a plurality of layers in a vertical direction, sets a filter media particle diameter of an upper layer side to a value that is larger than a filter media particle diameter of a lower layer side, and, with respect to the upward flow of backwash water that is passed through during backwashing of the filter media, sets the filter media to be capable of flowing on the upper layer side and to be incapable of flowing on the lower layer side.

Therefore, in a case in which the backwash cleansing Water is supplied from the backwash water supply pipe 35 during backwashing, and backwashing of the filter layer 32 is implemented by forming an upward flow inside the filter vessel 31, since the fluidity is limited to the upper section filter layer 32a, it is possible to prevent a circumstance in which the entirety of the sand of the filter layer 32 becomes fluid and becomes agitated and mixed together. That is, since the filter media of the lower section 32b attains a state in which the upper surface thereof is held down by the filter media of the upper section filtration layer 32a, the filter media of the lower section filtration layer 32b hardly flows even when subjected to the upward flow of the backwash cleansing water, and therefore, does not mix together with the filter media of the upper section filter layer 32a, which becomes fluid.

In this instance, as illustrated in FIG. 3B, the fluidity of the sand that forms the filter layer 32 refers to a phenomenon in which the sand rises as a result of being subject to the upward flow of the backwash cleansing water.

As described above, the secondary filtration device 30 of the biofilm filtration device is a device has a biofilm on a surface of a granular filter media filled into the filter vessel 31, the biofilm purifying water to he filtered by passing the water in the downward direction to the filter layer 32 in which sand is a filter media. Further, since the filter layer 32 is divided into two layers in the vertical direction, and the filter media particle diameter of the upper section filter layer 32a is set to a value that is larger than the filter media particle diameter of the lower section filter layer 32b, when subjected to the upward flow of backwash water during backwashing, the upper layer side filter media of the upper section filter layer 32a becomes fluid.

However, the light lower layer side filter media having a small diameter of the lower section filter layer 32b attains a state in which the upper surface thereof is held down by the heavy upper layer side filter media having a large diameter. Therefore, it is possible to prevent or suppress the fluidity of the lower layer filter media, and as a result, it is possible to prevent a circumstance in which the upper layer side filter media and the lower layer side filter media, which form the filter layer 32, become agitated and mixed together by backwashing.

Additionally, in the interest of preventing the fluidity of the lower layer side filter media, the particle diameter of the upper layer side filter media is approximately 1.5 to 3 times the particle diameter of the lower layer side filter media.

In this manner, in the secondary filtration device 30, in Which the filter layer 32 has a two-layered structure, even if upward flow of backwashing is implemented with the aim of removing a turbid portion that is attached to the biofilm of the surface of the filter media, the agitation and mixing together of sand is prevented or suppressed by controlling the fluidity of the sand that forms the filter layer 32.

Accordingly, since it is possible to prevent or suppress a circumstance in which a portion of the biofilm, which is attached to the surface of the filter media, forms fine particles as a result of peeling away, peeled-away fine particles that remain in the filter layer 32 do not age and form turbid portions.

Further, in the downflow type secondary filtration device 30, since there is a large amount of organic matter dissolved in the seawater On the upstream inlet opening 33 side, the organic attachment amount of the surface of the filter media is larger on the upstream side of the filtration material 32, and smaller on the downstream side, but because of the fact that agitation and mixing together are suppressed, a vertical reversal phenomenon of the organic attachment amount does not occur. Since aging because of organic nutrient deficiency is promoted in the lower section filter layer 32b, in which there is little dissolved organic matter, a large amount of suspended matter is generated in the filter layer 32, and then a turbid portion is mixed into filtration water and raises (worsens) the filtration water quality (SDI), and thus, this kind of vertical reversal phenomenon of the organic attachment amount is not preferable.

In such an instance, in order to relieve the fact that the backwashing, which is necessary in order to remove a turbid portion in seawater, leads to worsening of the filtration water quality, the abovementioned embodiment prevents mixing together because of fluidity by limiting portions in which the filter media can become fluid. In other words, since the prevention of peeling-away of the biofilm and the activation of biological activity are maintained by not allowing the biofilm on the surface of the filtration to become fluidized, it is possible to prevent worsening of the water quality of the filtration water.

Additionally, in the abovementioned embodiment, the filter layer 32 is divided vertically into two layers with different filter media particle diameters, but may be divided into a plurality of layers of three or more according to necessity.

### Third Embodiment

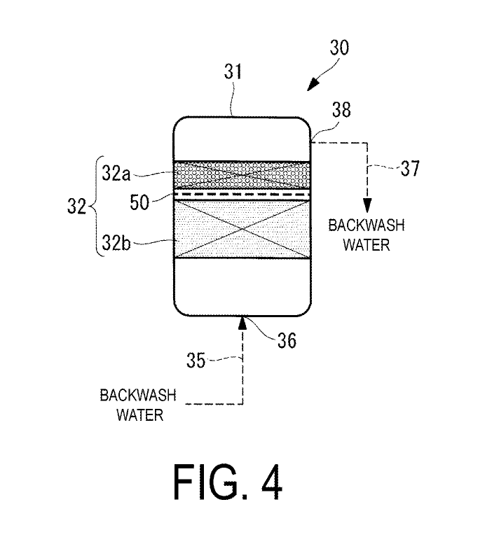

In addition, a reticulated material 50, which allows seawater and filtration water to pass therethrough, may be interposed between divided surfaces of the filter layer 32 as a mixture prevention material in the manner of a third embodiment that is illustrated in FIG. 4. This kind of reticulated material 50 prevents or suppresses the mixing together and movement of the filter medias as a result of being installed between the upper section filter layer 32a and the lower section filter layer 32b, and is capable of further reliably suppressing the fluidity of the light lower layer side filter media. Accordingly, in the lower layer side filter media, agitation and mixing together with the upper layer side filter media is reliably prevented.

### Fourth Embodiment

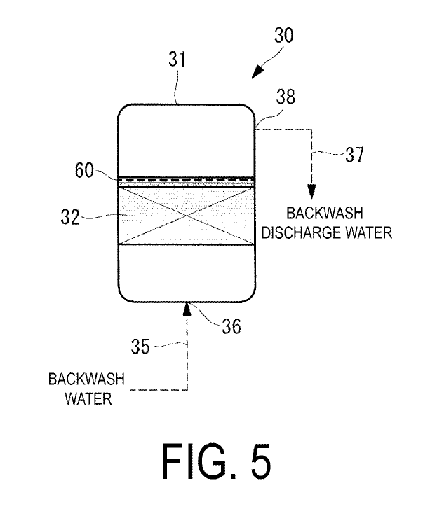

In addition, a grid structure material 60 may be installed on an upper surface of a filter layer 32, which is configured to have one layer, as a fluidization prevention material in the manner of a fourth embodiment that is illustrated in FIG. 5, Preferably, the grid structure material 60 allows seawater and filtration water to pass therethrough, and has a weight of an extent that does not float up as a result of the flow of backwash water.

Since this kind of grid structure material 60 further reliably prevents the fluidity by holding, the filter media down in a downward manner from the upper surface of the filter layer 32, it is possible to reliably prevent a circumstance in which the filter media becomes agitated and mixed together due to backwashing inside the filter layer 32. Additionally, although illustration has been omitted, by installing a grid structure material 60 on an upper surface as a fluidization prevention material in a filter layer 32 with two vertical layer, it is also possible to further reliably prevent the fluidity by holding down the filter medias of the upper section filter layer 32a and the lower section filter layer 32b in a downward manner.

According to the abovementioned present embodiment invention, since it is possible to prevent or suppress a circumstance in which the filter media becomes agitated and mixed together during backwashing, it is possible to easily achieve a desired filtration water quality level in raw water using water purification. Accordingly, the reliability of economical, non-polluting non-chemical-feed biofilm filtration devices (filtration methods) is improved, and such devices can be used in new large-scale plants.

Incidentally, in the abovementioned present embodiment, two-stage raw water purification is performed using the primary filtration device 20 and the secondary filtration device 30, but the number of the biofilm filtration devices that configure the purification device 10 is not particularly limited, and may be set to one stage, or three stages or more. In this case, although the biofilm filtration device that uses the abovementioned backwashing mechanism and backwash method is desirably adopted to a final stage or a stage that is close to the final stage, but the location is not particularly limited.

Additionally, the present invention is not limited to the embodiment as described above, and changes can be made as appropriate without departing from the gist thereof.

### Reference Signs List

1 Desalination plant

10 Purification device

11 Pipe

12 Connection pipe

13 Raw water pipe

20 Primary biofilm filtration device (primary filtration device)

21, 31 Filter vessel (filtration tower)

22, 32 Filter layer

23, 33 Inlet opening

24, 34 Outlet opening

25, 35 Backwash water supply pipe

26, 36 Backwash inlet opening

27, 37 Backwash discharge water pipe

28, 38 Backwash outlet opening

30 Secondary biofilm filtration device (secondary filtration device)

32a Upper section filter layer

32b Lower section filter layer

40 Desalination device

41 Pump

42 Reverse osmosis membrane

50 Reticulated material (mixture prevention material)

60 Grid structure material (fluidization prevention material)

1. A biofilm filtration device having a biofilm formed on a surface of a granular filter media filled into a filter vessel the biofilm purifying water to be filtered by passing the water in a filtration direction to a filter layer formed from the filter media, the biofilm filtration device comprising:
a backwashing mechanism that a flow velocity (V) for backwashing water passing through in a direction opposite to the filtration direction during backwashing of the filter media is set in a range having as lower limit which is a value at which a prescribed backwashing effect can be obtained, and an upper limit which is a value when a backwashing expansion coefficient for the filter media is 0.

2. The biofilm filtration device according to claim 1, wherein the flow velocity (V) for obtaining the predetermined backwashing effect is set to a value during which changes in turbidity or an uncleanness coefficient of backwash discharge water decrease to a predetermined value or less within a predetermined time after temporarily rising following initiation of backwashing.

3. A biofilm filtration device having a biofilm formed on a surface of a granular filter media filled into a filter vessel, the biofilm purifying water to be filtered by passing the water in a downward direction to a filter layer formed from the filter media, the biofilm filtration device comprising:
a plurality of layers divided from the filter layer in a vertical direction, a filter media particle diameter of an upper layer side being set to a value that is larger than a filter media particle diameter of a lower layer side.

4. The biofilm filtration device according to claim 3, wherein a mixture prevention material is interposed between divided surfaces of the filter layer.

5. The biofilm filtration device according to claim 3, wherein a fluidization prevention material is provided on an upper surface of the filter layer.

6. A biofilm filtration device having a biofilm formed on a surface of a granular filter media filled into a filter vessel, the biofilm purifying water to be filtered by passing the water in a downward direction to a filter layer formed from the filter media, the biofilm filtration device comprising:
a fluidization prevention material provided on an upper surface of the filter layer.

7. A backwash method for a biofilm filtration device having a biofilm formed on a surface of a granular filter media filled into a filter vessel, the biofilm purifying water to be filtered by passing the water in a filtration direction to a filter layer formed from the filter media, the method wherein a flow velocity (V) for backwashing water passing through in a direction opposite to the filtration direction during backwashing of the filter media is set in a range having a lower limit which is a value at which as prescribed backwashing effect can be obtained and an upper limit which is a value when a backwashing expansion coefficient for the filter media is 0.

8. The backwash method for the biofilm filtration device according to claim 7, wherein the flow velocity (V) for obtaining the predetermined backwashing effect is set to a value during which changes in turbidity or an uncleanness coefficient of backwash discharge water decrease to a predetermined value or less within a predetermined time after temporarily rising following initiation of backwashing.

9. A backwash method for a biofilm filtration device having a biofilm formed on a surface of a granular filter media filled into a filter vessel, the biofilm purifying water to be filtered by passing the water in a downward direction to a filter layer formed from the filter media, the method wherein a plurality of layers are divided from the filter layer in a vertical direction, and a filter media particle diameter of an upper layer side is set to a value that is larger than a filter media particle diameter of a lower layer side, and with respect to an upward flow of backwash water that is passed through during backwashing of the filter media, the filter media is set to be capable of flowing on the upper layer side and set to be incapable of flowing on the lower layer side.
